(19) United States
(12) Patent Application Publication
(10) Pub. No.: US 2026/0254511 A1
(43) Pub. Date: Aug. 27, 2026

(54) CHANNEL STATE INFORMATION FEEDBACK METHOD AND APPARATUS

(71) Applicant: Beijing Xiaomi Mobile Software Co., Ltd., Beijing (CN)

(72) Inventor: Xueyuan GAO, Beijing (CN)

(21) Appl. No.: 18/877,142

(22) PCT Filed: Jun. 30, 2022
(86) PCT No.: PCT/CN2022/103165

§ 371 Date: Dec. 19, 2024

(51) Int. Cl. H04B 7/06; H04W 72/0446

(52) U.S. Cl. CPC H04B 7/0639; H04B 7/0626; H04W 72/0446

(57) ABSTRACT

A method for feeding back channel state information (CSI) is performed by a terminal, and includes: determining codebook indication information corresponding to a data transmission layer based on a length of a time domain (TD) basis vector or a length of a Doppler domain (DD) basis vector, and a codebook parameter configured by a network-side device; and sending CSI comprising the codebook indication information to the network-side device, wherein the codebook indication information indicates the network-side device to determine precoding matrixes corresponding to different time instances.

### CROSS-REFERENCE TO RELATED APPLICATION

This application is a U.S. national phase of International Application No. PCT/CN2022/103165, filed Jun. 30, 2022, the entire content of which is incorporated herein by reference.

### TECHNICAL FIELD

The disclosure relates to a field of communication technologies, and particularly to a method and an apparatus for feeding back channel state information (CSI).

### BACKGROUND

For a terminal moving with a medium-high velocity, due to a rapid change of a channel in a time domain (TD), channel state information (CSI) is still fed back based on a conventional Type II codebook, such that the CSI fed back does not match current channel information, causing a decline in the system performance. Therefore, it is a problem to be solved how to enable the CSI fed back by the terminal in a medium-high velocity mobile scene to match the current channel information.

### SUMMARY

In a first aspect, an embodiment of the disclosure provides a method for feeding back CSI. The method is performed by a terminal. The method includes: determining codebook indication information corresponding to a data transmission layer based on a length of a TD basis vector or a length of a DD basis vector, and a codebook parameter configured by a network-side device; and sending CSI including the codebook indication information to the network-side device, in which the codebook indication information indicates the network-side device to determine precoding matrixes corresponding to different time instances.

In a second aspect, another embodiment of the disclosure provides a method for feeding back CSI. The method is performed by a network-side device. The method includes: determining a length of a TD basis vector or a length of a DD basis vector; configuring a codebook parameter for a terminal; sending the length of the TD basis vector or the length of the DD basis vector and the codebook parameter to the terminal; receiving codebook indication information corresponding to a data transmission layer determined by the length and the codebook parameter of the terminal; and determining precoding matrixes corresponding to different time instances based on the codebook indication information.

In a third aspect, an embodiment of the disclosure provides a terminal including a processor and a memory for storing a computer program executable by the processor. The processor is configured to execute the method in the first aspect.

In a fourth aspect, an embodiment of the disclosure provides a network-side device including a processor and a memory for storing a computer program executable by the processor. The processor is configured to execute the method in the second aspect.

### BRIEF DESCRIPTION OF THE DRAWINGS

The following is a brief description of the accompanying drawings of the disclosure.

FIG. 1 is a schematic diagram illustrating a communication system according to an embodiment of the disclosure.

FIG. 2 is a flow chart illustrating a method for feeding back channel state information (CSI) according to an embodiment of the disclosure.

FIG. 3 is a flow chart illustrating a method for feeding back channel state information (CSI) according to another embodiment of the disclosure.

FIG. 4 is a flow chart illustrating a method for feeding back channel state information (CSI) according to a yet another embodiment of the disclosure.

FIG. 5 is a flow chart illustrating a method for feeding back channel state information (CSI) according to a yet another embodiment of the disclosure.

FIG. 6 is a schematic diagram illustrating a relationship between a channel state information (CSI) measurement and a CSI reporting in a time domain (TD) according to an embodiment of the disclosure.

FIG. 7 is a block diagram illustrating a communication device according to an embodiment of the disclosure.

FIG. 8 is a block diagram illustrating a communication device according to another embodiment of the disclosure.

FIG. 9 is a block diagram illustrating a chip according to an embodiment of the disclosure.

### DETAILED DESCRIPTION

Reference is made in detail below to exemplary embodiments. Examples of embodiments are illustrated in the accompanying drawings, in which, the same or similar numbers represent the same or similar elements or elements with the same or similar functions. Embodiments described below with reference to the accompanying drawings are exemplary, which are intended to explain the disclosure and do not be understood a limitation of the disclosure. In the description of the disclosure, unless otherwise represented, “or” represents “or”, for example, “A or B” represents A or B, such as “a TD basis vector or a DD basis vector” herein represents the TD basis vector or the DD basis vector; “and/or” in the disclosure represents an association relationship that describes associated objects, indicating three cases, for example “A and/or B” represents, A alone, A and B simultaneously, and B alone.

For a terminal moving in a medium-high velocity, due to a rapid change of a channel in a time domain (TD), channel state information (CSI) is still fed back based on a traditional Type II codebook, such that the CSI fed back does not match current channel information, causing a decline in the system performance. In order to solve this problem, researches show that introducing the TD basis vector or the DD basis vector based on a Rel-16 or 17 Type II codebook may realize a precoding prediction at a future time instance, such that a predicted preset code matches a channel at a future time instance. A codebook structure corresponding to an enhanced CSI fed back based on the Rel-16 or 17 Type II codebook may be represented as

$$( {W}_{f}^{⋆} ⊗ {W}_{1} ) {W}_{2} {W}_{t}^{H} or {W}_{1} {{\tilde{W}}_{2} ( {W}_{f} ⊗ {W}_{d} )}^{H} ,$$

where W₁ in such two codebook structures represents a matrix combined by multiple spatial domain (SD) basis vectors or a unit matrix combined by at least one unit vector, W₂ represents a combination coefficient matrix, W_{f} represents a matrix combined by multiple frequency domain (FD) basis vectors, W_{d} represents a matrix combined by multiple Doppler domain (DD) basis vectors, and Wₜ represents a matrix combined by multiple TD basis vectors. In order to determine the TD basis vector or the DD basis vector used in the codebook, a length N₄ of the TD basis vector or a length N₄ of the DD basis vector need to be determined first. Presently, there is no way to determine the length N₄.

It should be noted that, in case that the TD basis vector or the DD basis vector is introduced to enhancement design of the Rel-16 or 17 Type II codebook in a medium-high velocity mobile scene, the length N₄ of the TD basis vector or the length N₄ of the DD basis vector needs to be determined first to calculate preset codes corresponding to different time instances. Therefore, embodiments of the disclosure provide a method and an apparatus for feeding back CSI. The length of the TD basis vector or the length of the DD basis vector may be determined, and the TD basis vector or the DD basis vector employed in the codebook is determined by employing the length. In this way, by introducing the TD basis vector or the DD basis vector on the basis of the Rel-16 or 17 Type II codebook, not only may the preset codes corresponding to different time instances be determined, but also a redundant configuration of a codebook parameter or a redundant report of a codebook parameter is avoided, thus reducing a signaling overhead.

In order to better understand a method for feeding back CSI in embodiments of the disclosure, first, description is made below to a communication system to which embodiments of the disclosure are applicable.

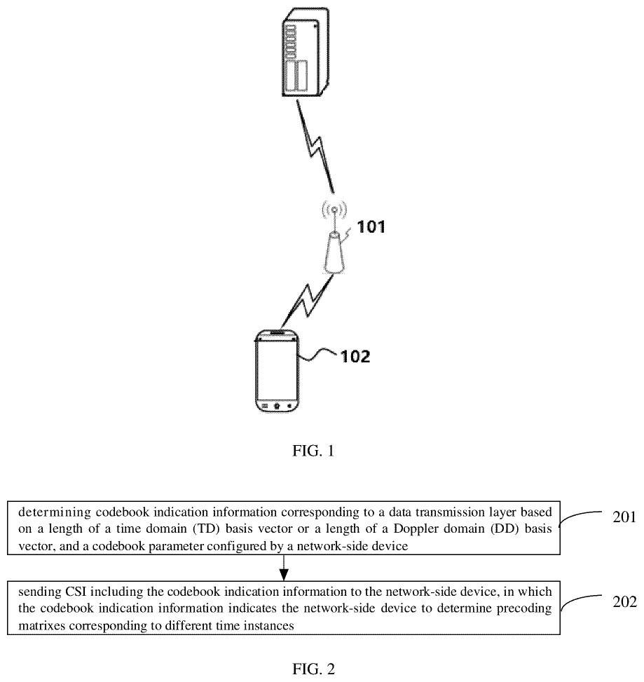

Referring to FIG. 1, FIG. 1 is a schematic diagram illustrating a communication system according to an embodiment of the disclosure. The communication system may include, but is not limited to, a network-side device and a terminal. The number and shape of devices illustrated in FIG. 1 are exemplary and do not constitute a limitation of embodiments of the disclosure. In a practical application, the communication system may include two or more network-side devices and two or more terminals. For example, the communication system illustrated in FIG. 1 includes a network-side device 101 and a terminal 102.

It should be noted that a technical solution of embodiments of the disclosure may be applied to various communication systems, such as, a long term evolution (LTE) system, a 5th generation (5G) mobile communication system, a 5G new radio (NR) system, or other new mobile communication systems in the future.

The network-side device 101 in embodiments of the disclosure is an entity in the network side for transmitting or receiving signals. For example, the network-side device 101 may be an evolved NodeB (eNB), a transmission reception point (TRP), or a next generation NodeB (gNB) in an NR system, a base station in other mobile communication systems in the future, or an access node in a wireless fidelity (WiFi) system. A detailed technology and a detailed device form employed by the network-side device are not limited in embodiments of the disclosure. The network-side device in embodiments of the disclosure may be combined by a central unit (CU) and a distributed unit (DU), in which CU may also be called a control unit. A protocol layer of the network device, such as the base station, may be separated by employing a CU-DU structure, in which, part of functions of the protocol layer are centrally controlled by the CU, while part or all of remaining functions of the protocol layer are distributed in the DU. The DU is controlled by the CU.

The terminal 102 in embodiments of the disclosure is an entity in a user side for receiving or transmitting signals, such as a mobile phone. The terminal may also be called a terminal, a user equipment (UE), a mobile station (MS), a mobile terminal (MT), etc. The terminal may be a car with a communication function, a smart car, a mobile phone, a wearable device, a Pad, a computer with a wireless receiving and sending function, a virtual reality (VR) terminal, an augmented reality (AR) terminal, a wireless terminal in industrial control, a wireless terminal in self-driving, a wireless terminal in a remote medical surgery, a wireless terminal in smart grid, a wireless terminal in transportation safety, a wireless terminal in a smart city, a wireless terminal in smart home, and so on. In addition, in embodiments of the disclosure, the terminal 102 may also include devices, such as relays, that are capable of performing data communication with the network-side device 101 (such as, a base station). A detailed technology and a detailed device form employed by the terminal are not limited in embodiments of the disclosure.

It may be understood that, the communication system in embodiments of the disclosure is intended to clearly describe the technical solution of embodiments of the disclosure, and does not constitute a limitation of the technical solution in embodiments of the disclosure. Those skilled in the art may know that, with the evolution of the system architecture and the emergence of a new service scene, the technical solution in embodiments of the disclosure is equally applicable to similar technical problems.

Description is made in detail below to the method and the apparatus for feeding back CSI in the disclosure in combination with accompanying drawings.

Referring to FIG. 2, FIG. 2 is a flowchart illustrating a method for feeding back CSI according to an embodiment of the disclosure. It should be noted that, the method for feeding back the CSI in embodiments of the disclosure may be performed by a terminal, that is, the method for feeding back the CSI in embodiments of the disclosure is described from a terminal side. As illustrated in FIG. 2, the method may include, but is not limited to, the following. At block 201, codebook indication information corresponding to a data transmission layer is determined based on a length of a TD basis vector or a length of a DD basis vector, and a codebook parameter configured by a network-side device.

Alternatively, the length of the TD basis vector or the length of the DD basis vector may be determined. In an implementation, the length may be determined by the terminal based on relevant information, or the length may also be configured by the network-side device. For example, the terminal may implicitly determine the length of the TD basis vector or the length of the DD basis vector based on a relevant parameter configured by the network-side device. Or, the terminal may determine the length of the TD basis vector or the length of the DD basis vector based on information, such as estimated Doppler offset information and an estimated Doppler extension. Or, the terminal may also receive the length of the TD basis vector or the length of the DD basis vector configured by the network-side device.

In an implementation, the terminal may receive a codebook parameter sent by the network-side device (such as a base station). The codebook parameter is configured by the network-side device, and used to indicate a maximum support parameter for a terminal to feed back the CSI information.

In an implementation, the terminal may receive the codebook parameter configured by the network-side device (such as the base station), and determine the codebook indication information corresponding to the data transmission layer based on the codebook parameter and the length of the TD basis vector. In embodiments of the disclosure, the codebook indication information may at least include, but not limited to, one or more combinations of a matrix combined by at least one SD basis vector, a combination coefficient matrix, a matrix combined by at least one FD basis vector, or a matrix combined by at least one TD basis vector. The length of the TD basis vector is configured to determine the TD basis vector employed in a codebook, and the TD basis vector is introduced on the basis of the Rel-16 or 17 Type II codebook. The term “at least one” may be understood as one or more, and the term “more” means at least two, such as two, three, etc., unless otherwise specified.

In an implementation, the terminal may receive the codebook parameter configured by the network-side device (such as the base station) and determine the codebook indication information corresponding to the data transmission layer based on the codebook parameter and the length of the DD basis vector. In embodiments of the disclosure, the codebook indication information may at least include, but not limited to, one or more combinations of the matrix combined by the at least one SD basis vector, the combination coefficient matrix, the matrix combined by the at least one FD basis vector, or a matrix combined by at least one DD basis vector. The length of the DD basis vector is used to determine the DD basis vector employed in the codebook, and the DD basis vector is introduced on the basis of the Rel-16 or 17 Type II codebook.

At block 202, CSI including the codebook indication information is sent to the network-side device, in which the codebook indication information indicates the network-side device to determine precoding matrixes corresponding to different time instances.

Alternatively, in case that the terminal determines the codebook indication information corresponding to the data transmission layer, the terminal may send the CSI including the codebook indication information to the network-side device. The network-side device may determine the precoding matrixes corresponding to different time instances based on the codebook indication information in the CSI when receiving the CSI sent by the terminal.

In an implementation, for example, the codebook indication information may include a matrix combined by multiple SD basis vectors, the combination coefficient matrix, a matrix combined by multiple FD basis vectors, and a matrix combined by multiple TD basis vectors. After the CSI including the codebook indication information is received, the network-side device may, based on the codebook indication information, calculate the precoding matrixes corresponding to different time instances by employing a codebook structure

$$( {W}_{f}^{⋆} ⊗ {W}_{1} ) {W}_{2} {W}_{t}^{H} ,$$

or predict the precoding matrixes corresponding to different time instances by employing a precoding matrix indicator (PMI) prediction algorithm, where W₁ represents the matrix combined by the multiple SD basis vectors or a unit matrix combined by at least one unit vector, W₂ represents the combination coefficient matrix, W_{f} represents the matrix combined by the multiple FD basis vectors, and Wₜ represents the matrix combined by the multiple TD basis vectors.

In an implementation, for example, the codebook indication information may include the matrix combined by the multiple SD basis vectors, the combination coefficient matrix, the matrix combined by the multiple FD basis vectors, and a matrix combined by multiple DD basis vectors. After the CSI including the codebook indication information is received, the network-side device may, based on the codebook indication information, calculate the precoding matrixes corresponding to different time instances by employing a codebook structure W₁\tilde{W}₂ (W_{f} ⊗W_{d})^{H}, or predict the precoding matrixes corresponding to different time instances by employing the PMI prediction algorithm, where W₁ represents the matrix combined by the multiple SD basis vectors or the unit matrix combined by the at least one unit vector, W₂ represents the combination coefficient matrix, W_{f} represents the matrix combined by the multiple FD basis vectors, and W_{d} represents the matrix combined by the multiple DD basis vectors.

By implementing embodiments of the disclosure, the length of the TD basis vector or the length of the DD basis vector may be determined, such that the TD basis vector or the DD basis vector employed in the codebook is determined based on the length. In this way, by introducing the TD basis vector or the DD basis vector on the basis of the Rel-16 or 17 Type II codebook, a precoding calculation or prediction at a future time instance may be realized, such that a calculated preset code or a predicted preset code matches a channel corresponding to a future time instance. Not only may the preset codes corresponding to different time instances be determined but also a redundant configuration of the codebook parameter or a redundant report of the codebook parameters may be avoided, thus reducing a signaling configuration overhead or a report feedback overhead.

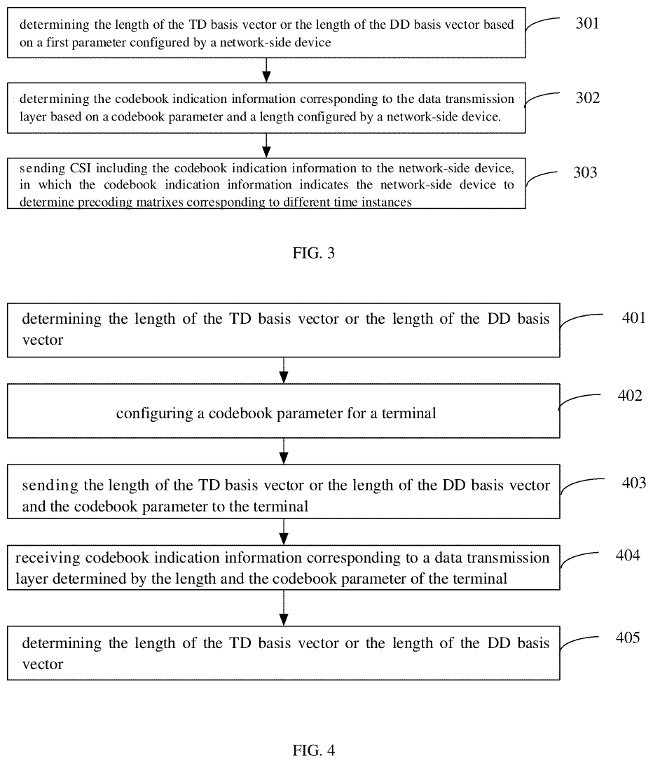

It should be noted that, the terminal may implicitly determine the length of the TD basis vector or the length of the DD basis vector based on the relevant parameter configured by the network-side device. In some embodiments of the disclosure, as illustrated in FIG. 3, the method for feeding back CSI may include, but is not limited to, the following. At block 301, the length of the TD basis vector or the length of the DD basis vector is determined based on a first parameter configured by a network-side device.

Alternatively, the terminal may implicitly determine the length of the TD basis vector or the length of the DD basis vector based on the first parameter configured by the network-side device. In some embodiments of the disclosure, the first parameter may include, but is not limited to, at least one of: a number of CSI-RS resources, a number of CSI-RS resources within a CSI-RS measurement window, a size of a CSI-RS measurement window, an interval between time instances of adjacent CSI measurements, a number of CSI measurements, a number of CSI measurements within a CSI-RS measurement window, or a parameter W. It should be noted that, the CSI-RS measurement window configured by the network-side device is to facilitate performing one or more channel measurements for the CSI-RS resources within a certain time range, and there may be a possibility that the CSI-RS measurement window is not configured by the network-side device.

In an implementation, for example, the first parameter is the number of CSI-RS resources or the number of CSI-RS resources within the CSI-RS measurement window, the length of the TD basis vector or the length of the DD basis vector may be determined based on the number of CSI-RS resources or the number of CSI-RS resources within the CSI-RS measurement window.

In an implementation, it may be determined that the length of the TD basis vector or the length of the DD basis vector is equal to the number of CSI-RS resources or the number of CSI-RS resources within the CSI-RS measurement window configured by the network-side device. For example, the number N_{CSI-RS} of CSI-RS resources configured by the network-side device is 4. Then it may be determined that the length N₄ of the TD basis vector or the length N₄ of the DD basis vector is 4. For another example, the number N_{CSI-RS} of the CSI-RS resources within the CSI-RS measurement window configured by the network-side device is 6. Then it may be determined that the length N₄ of the TD basis vector or the length N₄ of the DD basis vector is 6.

In an implementation, it may be determined that the length of the TD basis vector or the length of the DD basis vector is equal to Q₁ times of the number of CSI-RS resources configured by the network-side device, where Q₁ is a positive integer. For example, Q₁ is 1 and the number N_{CSI-RS} of CSI-RS resources configured by the network-side device is 4. Then it may be determined that the length N₄ of the TD basis vector or the length N₄ of the DD basis vector is 4.

In an implementation, it may be determined that the length of the TD basis vector or the length of the DD basis vector is equal to Q₁ times of the number of CSI-RS resources within the CSI-RS measurement window configured by the network-side device, where Q₁ is a positive integer. For example, Q₁ is 1 and the number N_{CSI-RS} of CSI-RS resources within the CSI-RS measurement window configured by the network-side device is 6, and then it may be determined that the length N₄ of the TD basis vector or the length N₄ of the DD basis vector is 6.

In an implementation, it may be determined that the length of the TD basis vector or the length of the DD basis vector is equal to

$$\frac{{N}_{CSI - RS}}{{C}_{u}} {Q}_{1} ,$$

where Q₁ is a positive integer, N_{CSI-RS} represents the number of CSI-RS resources or the number of CSI-RS resources within the CSI-RS measurement window configured by the network-side device, and Cᵤ represents a compression unit in a TD. For example, the Q₁ is 1, the number N_{CSI-RS} of CSI-RS resources configured by the network-side device is 4, and the Cᵤ is 2 ms. Then it may be determined that the length N₄ of the TD basis vector or the length N₄ of the DD basis vector is

$$\frac{4}{2} \times 1 = 2 ,$$

that is, the length N₄ of the TD basis vector or the length N₄ of the DD basis vector is 2.

It should be noted that, in embodiment of the disclosure, when the number NN_{CSI-RS} of CSI-RS resources is greater than 1, the N_{CSI-RS} CSI-RS resources may be in a same time domain type or different time domain types. The time domain type may be periodic, semi-persistent, and non-periodic types. In addition, in embodiments of the disclosure, when the number N_{CSI-RS} of CSI-RS resources is greater than 1, the N_{CSI-RS} CSI-RS resources may also be CSI-RS resources with different functions. For example, a CSI-RS resource is configured as a CSI-RS resource for channel acquisition, and the remaining CSI-RS resources are configured as CSI-RS resources for time-frequency tracking.

In some embodiments of the disclosure, for example, the first parameter is the size of the CSI-RS measurement window and the interval between the time instances of the adjacent CSI measurements. Then the length of the TD basis vector or the length of the DD basis vector may be determined based on the size of the CSI-RS measurement window and the interval between the time instances of the adjacent CSI measurements configured by the network-side device.

In an implementation, it may be determined that the length of the TD basis vector or the length of the DD basis vector is equal to

$$\frac{( {W}_{meas} - 1 )}{d} + 1 ,$$

where Wₘₑₐₛ represents the size of the CSI-RS measurement window, and d represents the interval between the time instances of the adjacent CSI measurements, or d represents a maximum interval or a minimum interval between adjacent CSI measurements, or d represents an average of intervals of multiple adjacent CSI measurements.

In some embodiments of the disclosure, for example, the first parameter is the number of CSI measurements or the number of CSI measurements within the CSI-RS measurement window. Then the length of the TD basis vector or the length of the DD basis vector may be determined based on the number of CSI measurements or the number of CSI measurements within the CSI-RS measurement window configured by the network-side device.

In an implementation, it may be determined that the length of the TD basis vector or the length of the DD basis vector is equal to the number of CSI measurements or the number of CSI measurements within the CSI-RS measurement window configured by the network-side device. For example, the number B of CSI measurements configured by the network-side device is 2. Then the length N₄ of the TD basis vector or the length N₄ of the DD basis vector is 2. For another example, the number B of CSI measurements within the CSI-RS measurement window configured by the network-side device is 2. Then the length N₄ of the TD basis vector or the length N₄ of the DD basis vector is 2.

In an implementation, it may be determined that the length of the TD basis vector or the length of the DD basis vector is equal to Q₂ times of the number of CSI measurements configured by the network-side device, where Q₂ is a positive integer.

In an implementation, it may be determined that the length of the TD basis vector or the length of the DD basis vector is equal to Q₂ times of the number of CSI measurements within the CSI-RS measurement window configured by the network-side device, where Q₂ is a positive integer.

In an implementation, it may be determined that the length of the TD basis vector or the length of the DD basis vector is equal to

$$\frac{B}{{C}_{u}} {Q}_{2} ,$$

where Q₂ is a positive integer, B represents the number of CSI measurements or the number of CSI measurements within the CSI-RS measurement window configured by the network-side device, and Cᵤ represents a compression unit in the TD. For example, the Q₂ is 1, the number B of CSI measurements or the number B of CSI measurements within the CSI-RS measurement window configured by the network-side device is 4, and the Cᵤ is 2 ms. Then the length N₄ of the TD basis vector or the length N₄ of the DD basis vector is

$$\frac{4}{2} \times 1 = 2 ,$$

that is, the length N₄ of the TD basis vector or the length N₄ of the DD basis vector is 2.

In some embodiments of the disclosure, for example, the first parameter is the parameter W. Then the length of the TD basis vector or the length of the DD basis vector may be determined based on the parameter W configured by the network-side device.

In an implementation, it may be determined that the length of the TD basis vector or the length of the DD basis vector is equal to

$$\frac{W}{{C}_{u}} ,$$

where W mod Cᵤ=0, Cᵤ represents the compression unit in the TD, and mod represents a modulo function. For example, a value of the parameter W is 4 and Cᵤ=2 ms. Then the length N₄ of the TD basis vector or the length N₄ of the DD basis vector is 2.

In an implementation, it may be determined that the length of the TD basis vector or the length of the DD basis vector is equal to

$$⌈ \frac{W}{{C}_{u}} ⌉ or ⌊ \frac{W}{{C}_{u}} ⌋ ,$$

where W mod Cᵤ≠0, ┌ ┐ represents ceiling, and └ ┘ represents flooring. For example, the value of the parameter W is 5 and Cᵤ=2 ms. Then the length N₄ of the TD basis vector or the length N₄ of the DD basis vector is

$$⌈ \frac{5}{2} ⌉ = 3 ,$$

or the length N₄ of the TD basis vector or the length N₄ of the DD basis vector is

$$⌊ \frac{5}{2} ⌋ = 2.$$

In some embodiments of the disclosure, the parameter W is determined by at least one of following parameters 1) to 4):
1) a time slot corresponding to a CSI reporting time instance;
2) a time slot where a CSI reference resource is located;
3) a time slot corresponding to a left boundary or a right boundary of a CSI-RS measurement window; or
4) a time slot corresponding to a left boundary or a right boundary of a CSI reporting window. It should be noted that, the CSI reporting window is configured by the network-side device, and the CSI reporting window configured aims to facilitate a description that the CSI is reported once within a certain time range, and there may be a possibility that the CSI reporting window is not configured.

For example, the parameter W represents the length W_{CSI} of the CSI reporting window, that is, W=W_{CSI}. Or, the parameter W represents the length Wₘₑₐₛ of the CSI measurement window, that is, W=Wₘₑₐₛ. Or, the parameter W represents a time length between a time slot corresponding to a time instance when a first CSI-RS resource is received for a CSI measurement and a time slot corresponding to a time instance when the right boundary of the CSI reporting window is located, and a unit of the length of the time is one time slot. Or, the parameter W represents a time length between the time slot corresponding to the right boundary or the left boundary of the CSI-RS measurement window and a time slot corresponding to a time instance when the right boundary of the CSI reporting window is located. Or, the parameter W represents a time length between the time slot corresponding to the CSI reference resource and a time slot corresponding to a time instance when the right boundary of the CSI reporting window is located.

It should be noted that, in embodiments of the disclosure, values of NN_{CSI-RS}, B, d, Q₁, Q₂, Wₘₑₐₛ, and Wₘₑₐₛ mentioned above may be reported by the terminal, configured by the network-side device, or pre-defined by the terminal and the network-side device.

In some embodiments of the disclosure, the terminal also needs to determine the compression unit Cᵤ of the TD. The compression unit Cᵤ may be determined in any of the following ways.

In an implementation, the compression unit Cᵤ may be αT_{c} where α is an integer less than or equal to 1, and T_{c} represents a channel coherence time. The coherence time

$${T}_{c} = \frac{1}{{f}_{d}} ,$$

where f_{d} represents a Doppler extension of the channel.

In an implementation, the compression unit Cᵤ may be a measurement period of the CSI-RS resource.

In an implementation, the compression unit Cᵤ may be βd₁, where β is an integer greater than or equal to 1, and d₁ represents the interval between the adjacent CSI measurements. For example, for multiple uniform CSI measurements, d₁ may represent the interval between the adjacent CSI measurements, and values of d₁ and β may be employed to determine the compression unit Cᵤ.

In an implementation, the compression unit Cᵤ may be βd₂, where β is an integer greater than or equal to 1, and d₂ represents a maximum interval or a minimum interval between adjacent CSI measurements, or d₂ may also represent an average of intervals of multiple adjacent CSI measurements. For example, for non-uniform multiple CSI measurements, d₂ may represent a maximum interval or a minimum interval between the adjacent CSI measurements, and values of d₂ and β may be employed to determine the compression unit Cᵤ.

It should be noted that, in embodiments of the disclosure, the values of a and 3 above may be reported by the terminal, or configured by the network-side device, or predefined by the terminal and the network-side device.

At block 302, codebook indication information corresponding to a data transmission layer is determined based on a codebook parameter and a length configured by a network-side device. Actions at block 302 may be respectively realized by employing any one of embodiments of the disclosure, which is not limited in embodiments of the disclosure and is not described in detail.

At block 303, CSI including the codebook indication information is sent to the network-side device, in which the codebook indication information indicates the network-side device to determine precoding matrixes corresponding to different time instances. Action at block 303 may be respectively realized by employing any one of embodiments of the disclosure, which is not limited in embodiments of the disclosure and is not described in detail.

By implementing embodiments of the disclosure, the length of the TD basis vector or the length of the DD basis vector may be implicitly determined based on the relevant parameter configured by the network-side device, so as to determine the TD basis vector or the DD basis vector used in the codebook based on the length. In this way, by introducing the TD basis vector or the DD basis vector on the basis of the Rel-16 or 17 Type II codebook, a precoding calculation or prediction at a future time instance may be realized, such that a calculated preset code or a predicted preset code matches a channel at a future time instance. Not only may preset codes corresponding to different time instances be determined, but also a redundant configuration of a codebook parameter or a redundant reporting of a codebook parameter may be avoided, thus reducing a signaling configuration overhead or a reporting feedback overhead.

It should be noted that, in some embodiments of the disclosure, the terminal may determine the length of the TD basis vector or the length of the DD basis vector based on estimated Doppler offset information and an estimated Doppler extension. For example, the terminal receives CSI-RS resources configured by the network-side device and performs CSI measurement processing by employing the CSI-RS resources to obtain the estimated Doppler offset information and the estimated Doppler extension. The terminal may determine the length of the TD basis vector or the length of the DD basis vector based on the estimated Doppler offset information and the estimated Doppler extension, thus determining the TD basis vector or the DD basis vector employed in the codebook by employing the length. In this way, by introducing the TD basis vector or the DD basis vector on the basis of the Rel-16 or 17 Type II codebook, a precoding calculation or prediction at a future time instance may be realized, such that a calculated preset code or a predicted preset code matches a channel at a future time instance. Not only may preset codes corresponding to different time instances be determined, but may also a redundant configuration of the codebook parameter or a redundant reporting of the codebook parameter may be avoided, thus reducing a signaling configuration overhead or a reporting feedback overhead.

In some embodiments of the disclosure, the terminal may receive the length of the TD basis vector or the length of the DD basis vector configured by the network-side device. That is, the length of the TD basis vector or the length of the DD basis vector may be configured for the terminal by the network-side device. The network-side device may implicitly determine the length of the TD basis vector or the length of the DD basis vector based on the relevant parameter (such as the first parameter mentioned above) configured by the network-side device, or the network-side device may determine the length of the TD basis vector or the length of the DD basis vector based on the Doppler offset information and the Doppler extension reported by the terminal. The network-side device may send the length of the TD basis vector or the length of the DD basis vector to the terminal when determining the length of the TD basis vector or the length of the DD basis vector of the terminal, such that the terminal may determine the TD basis vector or the DD basis vector employed in the codebook by employing the length. In this way, by introducing the TD basis vector or the DD basis vector on the basis of the Rel-16 or 17 Type II codebook, a precoding calculation or prediction at a future time instance may be realized, such that a calculated preset code or a predicted preset code matches a channel at a future time instance. Not only may preset codes corresponding to different time instances are determined, but may also a redundant configuration of the codebook parameter or a redundant reporting of the codebook parameters may be avoided, thus reducing a signaling configuration overhead or a reporting feedback overhead.

It may be understood that, the above embodiments are implementations of the method for feeding back the CSI of embodiments of the disclosure described from the terminal side. Embodiments of the disclosure also provide another method for feeding back CSI, and description is made below to implementations of the method for feeding back CSI from a network-side device. Referring to FIG. 4, FIG. 4 is a flow chart illustrating a method for feeding back CSI according to a yet another embodiment of the disclosure. It should be noted that, the method for feeding back the CSI of embodiments of the disclosure may be performed by the network-side device. As illustrated in FIG. 4, the method for feeding back the CSI may include but is not limited to the following.

At block 401, a length of a TD basis vector or a length of a DD basis vector is determined.

Alternatively, the network-side device may implicitly determine the length of the TD basis vector or the length of the DD basis vector based on a relevant parameter configured by the network-side device. Or, the network-side device may determine the length of the TD basis vector or the length of the DD basis vector based on information such as Doppler offset information and a Doppler extension reported by the terminal. For example, the terminal receives CSI-RS resources configured by the network-side device and performs CSI measurement processing by employing the CSI-RS resources to estimate the Doppler offset information and the Doppler extension. The terminal may report estimated Doppler offset information and a estimated Doppler extension to the network-side device, such that the network-side device may determine the length of the TD basis vector or the length of the DD basis vector based on the estimated Doppler offset information and the estimated Doppler extension.

At block 402, a codebook parameter is configured for a terminal.

At block 403, the length of the TD basis vector or the length of the DD basis vector and the codebook parameter are sent to the terminal.

In an implementation, the network-side device sends the length of the TD basis vector or the length of the DD basis vector and the codebook parameter to the terminal, such that the terminal determines codebook indication information corresponding to a data transmission layer based on the length of the TD basis vector or the length of the DD basis vector and the codebook parameter.

In an implementation, the terminal may receive the codebook parameter and the length of the TD basis vector configured by the network-side device (such as a base station), and determine the codebook indication information corresponding to the data transmission layer based on the codebook parameter and the length of the TD basis vector. In embodiments of the disclosure, the codebook indication information may at least include one or more combinations of: a matrix combined by at least one SD basis vector, a combination coefficient matrix, a matrix combined by at least one FD basis vector, or a matrix combined by at least one TD basis vector. The length of the TD basis vector is used to determine the TD basis vector employed in a codebook, and the TD basis vector is introduced on the basis of a Rel-16 or 17 Type II codebook.

In an implementation, the terminal may receive the codebook parameter and the length of the DD basis vector configured by the network-side device (such as the base station), and determine the codebook indication information corresponding to the data transmission layer based on the codebook parameter and the length of the DD basis vector. In embodiments of the disclosure, the codebook indication information may at least include, but not be limited to, one or more combinations of the matrix combined by the at least one SD basis vector, the combination coefficient matrix, the matrix combined by the at least one FD basis vector, or a matrix combined by at least one DD basis vector. The length of the DD basis vector is used to determine the DD basis vector employed in the codebook, and the DD basis vector is introduced on the basis of the Rel-16 or 17 Type II codebook.

At step 404, codebook indication information corresponding to a data transmission layer determined by the terminal based on the length and the codebook parameter is received.

Alternatively, after the terminal determines the codebook indication information corresponding to the data transmission layer based on the length of the TD basis vector or the length of the DD basis vector and the codebook parameter, the terminal sends the codebook indication information to the network-side device, such that the network-side device may receive the codebook indication information sent by the terminal.

At block 405, precoding matrixes corresponding to different time instances are determined based on the codebook indication information.

Alternatively, a codebook structure formula may be employed to calculate the precoding matrixes corresponding to different time instances based on the codebook indication information, or a PMI prediction algorithm may be employed to predict the precoding matrixes corresponding to different time instances.

In an implementation, for example, the codebook indication information may include a matrix combined by multiple SD basis vectors, the combination coefficient matrix, a matrix combined by multiple FD basis vectors, and a matrix combined by multiple TD basis vectors. After the CSI including the codebook indication information is received, the network-side device may, based on the codebook indication information, calculate the precoding matrixes corresponding to different time instances by employing a codebook structure

$$( {W}_{f}^{*} ⊗ {W}_{1} ) {W}_{2} {W}_{t}^{H} ,$$

or predict the precoding matrixes corresponding to different time instances by employing the PMI prediction algorithm, where W₁ represents the matrix combined by the multiple SD basis vectors or a unit matrix combined by at least one unit vector, W₂ represents the combination coefficient matrix, W_{f} represents the matrix combined by the multiple FD basis vectors, and Wₜ represents the matrix combined by multiple TD basis vectors.

In an implementation, for example, the codebook indication information may include the matrix combined by the multiple SD basis vectors, the combination coefficient matrix, the matrix combined by the multiple FD basis vectors, and a matrix combined by multiple DD basis vectors. After the CSI including the codebook indication information is received, the network-side device may, based on the codebook indication information, calculate the precoding matrixes corresponding to different time instances by employing a codebook structure W₁\tilde{W}₂ (W_{f} ⊗W_{d})^{H}, or predict the precoding matrixes corresponding to different time instances by employing the PMI prediction algorithm, where W₁ represents the matrix combined by the multiple SD basis vectors or the unit matrix combined by the at least one unit vector, W₂ represents the combination coefficient matrix, W_{f} represents the matrix combined by the multiple FD basis vectors, and W_{d} represents the matrix combined by the multiple DD basis vectors.

By implementing embodiments of the present disclosure, the length of the TD basis vector or the length of the DD basis vector may be determined, such that the TD basis vector or the DD basis vector employed in the codebook may be determined based on the length. In this way, by introducing the TD basis vector or the DD basis vector on the basis of the Rel-16 or 17 Type II codebook, a precoding calculation or prediction at a future time instance may be realized, such that a calculated preset code or a predicted preset code matches a channel at a future time instance. Not only may preset codes corresponding to different time instances be determined, but also a redundant configuration of a codebook parameter or a redundant reporting of a codebook parameter may be avoided, thus reducing a signaling configuration overhead or a reporting feedback overhead.

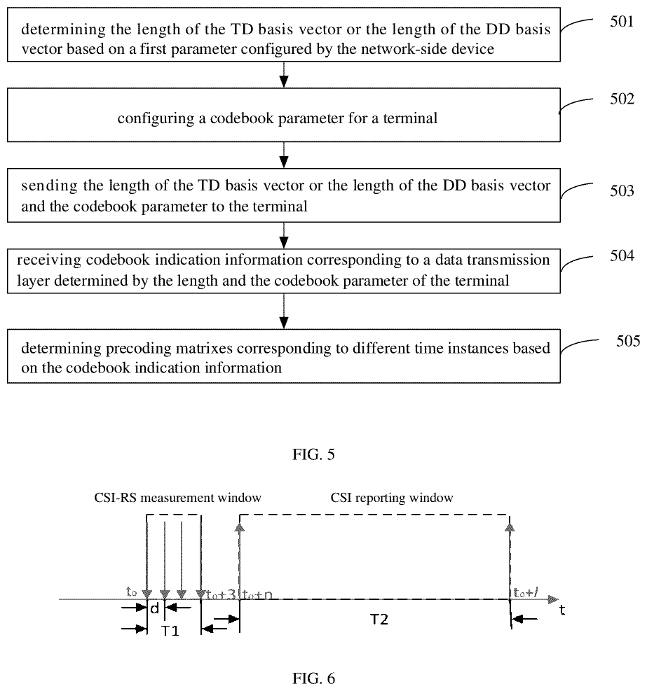

It should be noted that the network-side device may implicitly determine the length of the TD basis vector or the length of the DD basis vector based on the relevant parameter configured by the network-side device. In some embodiments of the disclosure, as illustrated in FIG. 5, the method for feeding back the CSI may include, but is not limited to, the following.

At block 501, a length of the TD basis vector or a length of the DD basis vector is determined based on a first parameter configured by the network-side device.

Alternatively, a terminal may implicitly determine the length of the TD basis vector or the length of the DD basis vector based on the first parameter configured by the network-side device. In some embodiments of the disclosure, the first parameter may include, but is not limited to, at least one of a number of CSI-RS resources, a number of CSI-RS resources within a CSI-RS measurement window, a size of a CSI-RS measurement window, an interval between time instances of adjacent CSI measurements, a number of CSI measurements, a number of CSI measurements within a CSI-RS measurement window, or a parameter W. It should be noted that the CSI-RS measurement window configured by the network-side device is to facilitate description that one or more channel measurements is performed for the CSI-RS resources within a certain time, and there may be a possibility that the CSI-RS measurement window is not configured by the network-side device.

In an implementation, for example, the first parameter is the number of CSI-RS resources or the number of CSI-RS resources within the CSI-RS measurement window, the length of the TD basis vector or the length of the DD basis vector may be determined based on the number of CSI-RS resources or the number of CSI-RS resources within the CSI-RS measurement window.

In an implementation, it may be determined that the length of the TD basis vector or the length of the DD basis vector is equal to the number of CSI-RS resources or the number of CSI-RS resources within the CSI-RS measurement window configured by the network-side device. For example, the number NN_{CSI-RS} of CSI-RS resources configured by the network-side device is 4. Then it may be determined that the length N₄ of the TD basis vector or the length N₄ of the DD basis vector is 4. For another example, the number NN_{CSI-RS} of the CSI-RS resources within the CSI-RS measurement window configured by the network-side device is 6. Then it may be determined that the length N₄ of the TD basis vector or the length N₄ of the DD basis vector is 6.

In an implementation, it may be determined that the length of the TD basis vector or the length of the DD basis vector is equal to Q₁ times of the number of CSI-RS resources configured by the network-side device, where Q₁ is a positive integer. For example, Q₁ is 1, and the number N_{CSI-RS} of CSI-RS resources configured by the network-side device is 4. Then it may be determined that the length N₄ of the TD basis vector or the length N₄ of the DD basis vector is 4.

In an implementation, it may be determined that the length of the TD basis vector or the length of the DD basis vector is equal to Q₁ times of the number of CSI-RS resources within the CSI-RS measurement window configured by the network-side device, where Q₁ is a positive integer. For example, Q₁ is 1, and the number N_{CSI-RS} of CSI-RS resources within the CSI-RS measurement window configured by the network-side device is 6. Then it may be determined that the length N₄ of the TD basis vector or the length N₄ of the DD basis vector is 6.

In an implementation, it may be determined that the length of the TD basis vector or the length of the DD basis vector is equal to

$$\frac{{N}_{CSI - RS}}{{C}_{u}} {Q}_{1} ,$$

where Q₁ is a positive integer, N_{CSI-RS} represents the number of CSI-RS resources or the number of CSI-RS resources within the CSI-RS measurement window configured by the network-side device, and Cᵤ represents a compression unit in a TD. For example, the Q₁ is 1, the number N_{CSI-RS} of CSI-RS resources configured by the network-side device is 4, and the Cᵤ is 2 ms. Then it may be determined that the length N₄ of the TD basis vector or the length N₄ of the DD basis vector is

$$\frac{4}{2} \times 1 = 2 ,$$

that is, the length N₄ of the TD basis vector or the length N₄ of the DD basis vector is 2.

It should be noted that, in embodiment of the disclosure, when the number N_{CSI-RS} of CSI-RS resources is greater than 1, the N_{CSI-RS} CSI-RS resources may be in a same time domain type or different time domain types. The time domain type may be periodic, semi-persistent, and non-periodic types. In addition, in embodiments of the disclosure, when the number NN_{CSI-RS} of CSI-RS resources is greater than 1, the NN_{CSI-RS} CSI-RS resources may also be CSI-RS resources with different functions. For example, a CSI-RS resource is configured as a CSI-RS resource for channel acquisition, and the remaining CSI-RS resources are configured as CSI-RS resources for time-frequency tracking.

In some embodiments of the disclosure, for example, the first parameter is the size of the CSI-RS measurement window and the interval between the time instances of the adjacent CSI measurements. Then the length of the TD basis vector or the length of the DD basis vector may be determined based on the size of the CSI-RS measurement window and the interval between the time instances of the adjacent CSI measurements configured by the network-side device.

In an implementation, it may be determined that the length of the TD basis vector or the length of the DD basis vector is equal to

$$\frac{( {W}_{meas} - 1 )}{d} + 1 ,$$

where Wₘₑₐₛ represents the size of the CSI-RS measurement window, and d represents the interval between the time instances of the adjacent CSI measurements, d represents a maximum interval or a minimum interval between adjacent CSI measurements, or d represents an average of intervals of multiple adjacent CSI measurements.

In some embodiments of the disclosure, for example, the first parameter is the number of CSI measurements or the number of CSI measurements within the CSI-RS measurement window. Then the length of the TD basis vector or the length of the DD basis vector may be determined based on the number of CSI measurements or the number of CSI measurements within the CSI-RS measurement window configured by the network-side device.

In an implementation, it may be determined that the length of the TD basis vector or the length of the DD basis vector is equal to the number of CSI measurements or the number of CSI measurements within the CSI-RS measurement window configured by the network-side device. For example, the number B of CSI measurements configured by the network-side device is 2. Then the length N₄ of the TD basis vector or the length N₄ of the DD basis vector is 2. For another example, the number B of CSI measurements within the CSI-RS measurement window configured by the network-side device is 2. Then the length N₄ of the TD basis vector or the length N₄ of the DD basis vector is 2.

In an implementation, it may be determined that the length of the TD basis vector or the length of the DD basis vector is equal to Q₂ times of the number of CSI measurements configured by the network-side device, where Q₂ is a positive integer.

In an implementation, it may be determined that the length of the TD basis vector or the length of the DD basis vector is equal to Q₂ times of the number of CSI measurements within the CSI-RS measurement window configured by the network-side device, where Q₂ is a positive integer.

In an implementation, it may be determined that the length of the TD basis vector or the length of the DD basis vector is equal to

$$\frac{B}{{C}_{u}} {Q}_{2} ,$$

where Q₂ is a positive integer, B represents the number of CSI measurements or the number of CSI measurements within the CSI-RS measurement window configured by the network-side device, and Cᵤ represents a compression unit in the TD. For example, the Q₂ is 1, the number B of CSI measurements or the number B of CSI measurements within the CSI-RS measurement window configured by the network-side device is 4, and the Cᵤ is 2 ms. Then the length N₄ of the TD basis vector or the length N₄ of the DD basis vector is

$$\frac{4}{2} \times 1 = 2 ,$$

that is, the length N₄ of the TD basis vector or the length N₄ of the DD basis vector is 2.

In some embodiments of the disclosure, for example, the first parameter is the parameter W. Then the length of the TD basis vector or the length of the DD basis vector may be determined based on the parameter W configured by the network-side device.

In an implementation, it may be determined that the length of the TD basis vector or the length of the DD basis vector is equal to

$$\frac{W}{{C}_{u}} ,$$

where W mod Cᵤ=0, Cᵤ represents the compression unit in the TD, and mod represents a modulo function. For example, a value of the parameter W is 4 and Cᵤ=2 ms. Then the length N₄ of the TD basis vector or the length N₄ of the DD basis vector is 2.

In an implementation, it may be determined that the length of the TD basis vector or the length of the DD basis vector is equal to

$$⌈ \frac{W}{{C}_{u}} ⌉ or ⌊ \frac{W}{{C}_{u}} ⌋ ,$$

where W mod Cᵤ=0, ┌ ┐ represents ceiling, and └ ┘ represents flooring. For example, the value of the parameter W is 5 and Cᵤ=2 ms. Then the length N₄ of the TD basis vector or the length N₄ of the DD basis vector is

$$⌈ \frac{5}{2} ⌉ = 3 ,$$

or the length N₄ of the TD basis vector or the length N₄ of the DD basis vector is

$$⌊ \frac{5}{2} ⌋ = 2.$$

In some embodiments of the disclosure, the parameter W is determined by at least one of following parameters 1) to 4):
1) a time slot corresponding to a CSI reporting time instance;
2) a time slot where a CSI reference resource is located;
3) a time slot corresponding to a left boundary or a right boundary of a CSI-RS measurement window; or
4) a time slot corresponding to a left boundary or a right boundary of a CSI reporting window. It should be noted that, the CSI reporting window is configured by the network-side device, and the CSI reporting window configured aims to facilitate a description that the CSI is reported once within a certain time range, and there may be a possibility that the CSI reporting window is not configured.

For example, the parameter W represents the length W_{CSI} of the CSI reporting window, that is, W=W_{CSI}. Or, the parameter W represents the length Wₘₑₐₛ of the CSI measurement window, that is, W=Wₘₑₐₛ. Or, the parameter W represents a time length between a time slot corresponding to a time instance when a first CSI-RS resource is received for a CSI measurement and a time slot corresponding to a time instance when the right boundary of the CSI reporting window is located, and a unit of the length of the time is one time slot. Or, the parameter W represents a time length between the time slot corresponding to the right boundary or the left boundary of the CSI-RS measurement window and a time slot corresponding to a time instance when the right boundary of the CSI reporting window is located. Or, the parameter Wrepresents a time length between the time slot corresponding to the CSI reference resource and a time slot corresponding to a time instance when the right boundary of the CSI reporting window is located

It should be noted that, in embodiments of the disclosure, values of N_{CSI-RS}, B, d, Q₁, Q₂, Wₘₑₐₛ, and Wₘₑₐₛ mentioned above may be reported by the terminal, configured by the network-side device, or pre-defined by the terminal and the network-side device.

In some embodiments of the disclosure, the network-side device also needs to determine the compression unit Cᵤ of the TD. The compression unit Cᵤ may be determined in any of the following ways.

In an implementation, the compression unit Cᵤ may be αT_{c}, where α is an integer less than or equal to 1, and T_{c} represents a channel coherence time. The coherence time

$${T}_{c} = \frac{1}{{f}_{d}} ,$$

where f_{d} represents a Doppler extension of the channel.

In an implementation, the compression unit Cᵤ may be a measurement period of the CSI-RS resource.

In an implementation, the compression unit Cᵤ may be βd₁, where β is an integer greater than or equal to 1, and d₁ represents the interval between the adjacent CSI measurements. For example, for multiple uniform CSI measurements, d₁ may represent the interval between the adjacent CSI measurements, and values of d₁ and β may be employed to determine the compression unit Cᵤ.

In an implementation, the compression unit Cᵤ may be βd₂, where β is an integer greater than or equal to 1, and d₂ represents a maximum interval or a minimum interval between adjacent CSI measurements, or d₂ may also represent an average of intervals of multiple adjacent CSI measurements. For example, for non-uniform multiple CSI measurements, d₂ may represent a maximum interval or a minimum interval between the adjacent CSI measurements, and values of d₂ and β may be employed to determine the compression unit Cᵤ.

For example, it is assumed that the terminal (UE) moves at a velocity of 27 Km/h, and a system carrier frequency of a cell where the UE is located is 4 GHz. Then a maximum Doppler extension of the user may be represented by f_{d}=100 Hz, and a channel coherence time of the UE may be represented as

$${T}_{c} = \frac{1}{{f}_{d}} = 10 ms .$$

The compression unit used to determine the length N₄ of the TD or the length N₄ of the DD basis vector may be represented by Cᵤ=αT_{c}. In case that α is 0.5 configured by the network-side device, the compression unit Cᵤ=αT_{c}=5 ms. For another example, an interval of adjacent CSI-RS resource measurements configured by the network-side device is d=2 ms, the compression unit Cᵤ=dβ. It is assumed that the value of β is predefined value 1. Then the compressed unit Cᵤ=2 ms. Then the length N₄ of the TD or the length N₄ of the DD basis vector is equal to W or Cᵤ. The meaning of the W may be represented by any one of the above meanings.

It should be noted that, in embodiments of the disclosure, the values of α and β above may be reported by the terminal, configured by the network-side device, or predefined by the terminal and the network-side device. In addition, f_{d} mentioned above may be reported to the network-side device by the terminal.

At block 502, a codebook parameter is configured for a terminal. Actions at block 502 may be respectively realized by employing any one of embodiments of the disclosure, which is not limited in embodiments of the disclosure and is not described in detail.

At block 503, the length of the TD basis vector or the length of the DD basis vector and the codebook parameter are sent to the terminal. Actions at block 503 may be respectively realized by employing any one of embodiments of the disclosure, which is not limited in embodiments of the disclosure and is not described in detail.

At block 504, codebook indication information corresponding to a data transmission layer determined by the terminal based on the length and the codebook parameter is received. Actions at block 504 may be respectively realized by employing any one of embodiments of the disclosure, which is not limited in embodiments of the disclosure and is not described in detail.

At block 505, precoding matrixes corresponding to different time instances are determined based on the codebook indication information.

In an implementation, the precoding matrixes corresponding to different time instances are determined by employing a codebook structure or a PMI prediction algorithm based on the codebook indication information and a way of determining the length of the TD basis vector or the length of the DD basis vector. In other words, in case that different ways are employed to determine the length N₄ of the TD basis vector or the length N₄ of the DD basis vector, the precoding matrixes are obtained in different ways, such as employing the prediction algorithm to predict the precoding matrixes, or directly employing the codebook structure to calculate the precoding matrixes.

For example, it is assumed that the network-side device (such as a base station) configures a non-periodic CSI-RS resource set to the terminal (UE), and the non-periodic CSI-RS resource set includes four non-periodic CSI-RS resources. Downlink channel information at four different time instances within one CSI-RS measurement window is measured based on the four non-periodic CSI-RS resources, and an interval of adjacent CSI-RS resources is d. FIG. 6 illustrates a relationship between a CSI-RS measurement and a CSI reporting in a TD, where a measurement time instance of the first CSI-RS resource is to, and a measurement time instance of a last CSI-RS resource is t₀+3. Based on the downlink channels measured at the CSI-RS resources at the four different time instances and based on the codebook parameter configured by the base station, the UE calculates W₁ combined by the multiple SD basis vectors, the combination coefficient W₂, W_{f} combined by the multiple FD basis vectors, and Wₜ or W_{d} combined by the multiple TD basis vectors or DD basis vectors in the codebook. The UE reports these parameters to the base station at time t₀+n, and the base station calculates the precoding matrixes corresponding to time instances with the length N₄ by employing

$$( {W}_{f}^{*} ⊗ {W}_{1} ) {W}_{2} {W}_{t}^{H} or {W}_{1} {{\tilde{W}}_{2} ( {W}_{f} ⊗ {W}_{d} )}^{H} .$$

t₀+n represents the left boundary of the CSI reporting window, and t₀+l represents the right boundary of the CSI reporting window. The length N₄ of the TD basis vector or the length N₄ of the DD basis vector is equal to the number 4 of CSI-RS resources within the CSI-RS measurement window as illustrated in FIG. 6, or the length N₄ of the TD or the length N₄ of the DD basis vector is equal to the number B=4 of CSI-RS measurements within the CSI-RS measurement window, or, the length N₄ of the TD or the length N₄ of the DD basis vector is equal to

$$\frac{( {W}_{m e a s} - 1 )}{d} + 1 = 4 ,$$

where Wₘₑₐₛ=4, and d=1. When N₄=4, the base station may employ the PMI prediction algorithm to calculate precoding matrixes corresponding to different time instances with a time range from t₀+3 to t₀+l.

For example, when the length N₄ of the TD basis vector or the length N₄ of the DD basis vector is defined as

$$\frac{{W}_{CSI}}{{C}_{u}} ,$$

where W_{CSI} represents a length of the CSI reporting window and Cᵤ represents the compression unit in the TD. The length N₄ is configured for the UE by the base station via a radio resource control (RRC) signaling, and the UE reports S (S>1) selected basis vectors with a length N₄ to the base station. Then the base station may employ the above codebook algorithm to directly calculate the precoding matrixes corresponding to different time instances within the CSI reporting window. For another example, when the length N₄ of the TD basis vector or the length N₄ of the DD basis vector is equal to Q times of B, or the length N₄ of the TD basis vector or the length N₄ of the DD basis vector is equal to Q times of B or Cᵤ, where B=4, Q=5, Cᵤ=1, that is, N₄=20. Let a matrix combined by V≥1 TD basis vectors or DD basis vectors being represented as W_{d}=[f_{d,l} . . . f_{d,V}]∈C^{T×V}, where a V^{th} TD basis vector or DD basis vector is presented by

$${f}_{d , ν} = [ 1 , {e}^{j \frac{2 π v}{{N}_{4}}} , … , {e}^{j \frac{2 π v ( {N}_{4} - 1 )}{{N}_{4}}} ] .$$

The precoding matrixes corresponding to N₄ time instances may be obtained by

$$( {W}_{f}^{*} ⊗ {W}_{1} ) {W}_{2} {W}_{t}^{H} or {W}_{1} {{\tilde{W}}_{2} ( {W}_{f} ⊗ {W}_{d} )}^{H} ,$$

where Wₗ and W_{f} follow a conventional calculation way of the Rel-16 or 17 Type II, and W_{d} or Wₜ selects the V basis vectors from the codebook combined by the basis vectors with the length N₄.

For calculating precoding matrixes corresponding to N₅ time instances after the N₄ time instances, that is, predicting precoding matrixes corresponding to N₅>N₄ time instances may be calculated in the following ways: first, let t_{d}=[1, . . . , e^{j2πvq}, . . . e^{j2πv(Q-1)}]^{T} ⊗f_{d,v}, v∈{1, . . . ,V}, then Wₜ_{_{d}}=[t_{d}_{₁} . . . t_{d}_{ᵥ}]∈C N^{N}^{₅}^{×V}, where N₅=QN₄. Then, the base station calculates the precoding matrixes corresponding to the N₅ time instances by

$$( {W}_{f}^{*} ⊗ {W}_{1} ) {{W}^{\approx }}_{2} {W}_{{t}_{d}}^{H} .$$

In conclusion, in embodiments of the disclosure, the length of the TD basis vector or the length of the DD basis vector may be determined, and then the TD basis vector or the DD basis vector employed in the codebook is determined by employing the length. In this way, by introducing the TD basis vector or the DD basis vector on the basis of the Rel-16 or 17 Type II codebook, a precoding calculation or prediction at a future time instance may be realized, such that a calculated preset code or a predicted preset code matches a channel at a future time instance. Not only may preset codes corresponding to different time instances be determined, but also a redundant configuration of the codebook parameter or a redundant reporting of the codebook parameter may be avoided, thus reducing a signaling configuration overhead or a reporting feedback overhead.

In the embodiments of the disclosure, the method is introduced from the perspective of terminal and network-side device. In order to realize the functions of the method in the above embodiments of the disclosure, the terminal and the network-side device may include a hardware structure and a software module in order to realize the above functions in the form of a hardware structure, a software module, or a hardware structure plus a software module. One of these functions may be performed by a hardware structure, a software module, or a hardware structure plus a software module.

Referring to FIG. 7, FIG. 7 is a block diagram illustrating a communication device 70 according to an embodiment of the disclosure. The communication device 70 illustrated in FIG. 7 may include a receiving and sending module 701 and a processing module 702. The receiving and sending module 701 may include a sending module and/or a receiving module. The sending module is configured to achieve a sending function, the receiving module is configured to achieve a receiving function, and the receiving and sending module 701 may achieve the sending function and/or the receiving function.

The communication device 70 may be a terminal, a device in a terminal, or a device used in combination with a terminal. Or, the communication device 70 may be a network-side device, a device within a network-side device, or a device used in combination with a network-side device.

The communication device 70 is the terminal. The processing module 702 is configured to determine codebook indication information corresponding to a data transmission layer based on a length of a TD basis vector or a length of a DD basis vector, and a codebook parameter configured by a network-side device; and the receiving and sending module 701 is configured to send CSI including the codebook indication information to the network-side device, in which the codebook indication information indicates the network-side device to determine precoding matrixes corresponding to different time instances.

In an implementation, the processing module 702 is specifically configured to: determine the length of the TD basis vector or the length of the DD basis vector; and determine the codebook indication information corresponding to the data transmission layer based on the length and the codebook parameter configured by the network-side device.

In an implementation, the processing module 702 is specifically configured to determine the length of the TD basis vector or the length of the DD basis vector based on a first parameter configured by the network-side device.

In an implementation, the first parameter is a number of CSI-RS resources or a number of CSI-RS resources within a CSI-RS measurement window. The processing module 702 is specifically configured to determine that the length of the TD basis vector or the length of the DD basis vector is equal to the number of CSI-RS resources or the number of CSI-RS resources within the CSI-RS measurement window configured by the network-side device; determine that the length of the TD basis vector or the length of the DD basis vector is equal to Q₁ times of the number of CSI-RS resources configured by the network-side device; determine that the length of the TD basis vector or the length of the DD basis vector is equal to Q₁ times of the number of CSI-RS resources within the CSI-RS measurement window configured by the network-side device; or determine that the length of the TD basis vector or the length of the DD basis vector is equal to

$$\frac{{N}_{CSI - RS}}{{C}_{u}} {Q}_{1} ,$$

where Q₁ is a positive integer, N_{CSI-RS} represents the number of CSI-RS resources or the number of CSI-RS resources within the CSI-RS measurement window configured by the network-side device, and Cᵤ represents a compression unit in a TD.

In an implementation, the first parameter is a size of a CSI-RS measurement window and an interval between time instances of adjacent CSI measurements. The processing module 702 is specifically configured to determine that the length of the TD basis vector or the length of the DD basis vector is equal to

$$\frac{( {W}_{meas} - 1 )}{d} + 1 ,$$

where Wₘₑₐₛ represents the size of the CSI-RS measurement window, and d represents the interval between the time instances of the adjacent CSI measurements, a maximum interval or a minimum interval between adjacent CSI measurements, or an average of intervals of multiple adjacent CSI measurements.

In an implementation, the first parameter is a number of CSI measurements or a number of CSI measurements within a CSI-RS measurement window. The processing module 702 is specifically configured to determine that the length of the TD basis vector or the length of the DD basis vector is equal to the number of CSI-RS measurements or the number of CSI-RS measurements within the CSI-RS measurement window configured by the network-side device; determine that the length of the TD basis vector or the length of the DD basis vector is equal to Q₂ times of the number of CSI measurements configured by the network-side device; determine that the length of the TD basis vector or the length of the DD basis vector is equal to Q₂ times of the number of CSI measurements within the CSI-RS measurement window configured by the network-side device; or determine that the length of the TD basis vector or the length of the DD basis vector is equal to

$$\frac{B}{{C}_{u}} {Q}_{2} ,$$

where Q₂ is a positive integer, B represents the number of CSI measurements or the number of CSI measurements within the CSI-RS measurement window configured by the network-side device, and Cᵤ represents a compression unit in a TD.

In an implementation, the first parameter is a parameter W. The processing module 702 is specifically configured to determine that the length of the TD basis vector or the length of the DD basis vector is equal to

$$\frac{W}{{C}_{u}} ,$$

where W mod Cᵤ=0, and Cᵤ represents a compression unit in a TD; or determine that the length of the TD basis vector or the length of the DD basis vector is equal to

$$⌈ \frac{W}{{C}_{u}} ⌉$$

$$or$$

$$⌊ \frac{W}{{C}_{u}} ⌋ ,$$

where W mod Cᵤ≠0, ┌ ┐ represents ceiling, and └ ┘ represents flooring, in which the parameter W is determined by at least one of following parameters 1) to 4): 1) a time slot corresponding to a CSI reporting time instance; 2) a time slot where a CSI reference resource is located; 3) a time slot corresponding to a left boundary or a right boundary of a CSI-RS measurement window; or 4) a time slot corresponding to a left boundary or a right boundary of a CSI reporting window.

In an implementation, the processing module 702 is further configured to determine the compression unit Cᵤ in the TD.

In an implementation, the compression unit Cᵤ is αT_{c}, where α is an integer less than or equal to 1, and T_{c} represents a channel coherence time; the compression unit Cᵤ is a measurement period of the CSI-RS resource; the compression unit Cᵤ is βd₁, where β is an integer greater than or equal to 1, and d₁ represents the interval between the adjacent CSI measurements; or the compression unit Cᵤ is βd₂, where β is an integer greater than or equal to 1, and d₂ represents the maximum interval or the minimum interval between the adjacent CSI measurements, or the average of the intervals of the multiple adjacent CSI measurements.

In an implementation, the processing module 702 is specifically configured to determine the length of the TD basis vector or the length of the DD basis vector based on Doppler offset information and a Doppler extension estimated based on a CSI-RS by the terminal.

In an implementation, the processing module 701 is further configured to receive the length of the TD basis vector or the length of the DD basis vector configured by the network-side device.

In an implementation, the codebook indication information at least includes one or more combinations of: a matrix combined by at least one SD basis vector, a combination coefficient matrix, a matrix combined by at least one FD basis vector, or a matrix combined by at least one TD basis vector or at least one DD basis vector.

The communication device 70 is the network-side device. The processing module 702 is configured to determine a length of a TD basis vector or a length of a DD basis vector; the processing module 702 is further configured to configure a codebook parameter for a terminal; the receiving and sending module 701 is configured to send the length of the TD basis vector or the length of the DD basis vector and the codebook parameter to the terminal; the receiving and sending module 701 is further configured to receive codebook indication information corresponding to a data transmission layer determined by the length and the codebook parameter of the terminal; and the processing module 702 is further configured to determine precoding matrixes corresponding to different time instances based on the codebook indication information.

In an implementation, the processing module 702 is specifically configured to determine the length of the TD basis vector or the length of the DD basis vector based on a first parameter configured by the network-side device.

In an implementation, the first parameter is a number of CSI-RS resources or a number of CSI-RS resources within a CSI-RS measurement window. The processing module 702 is specifically configured to determine that the length of the TD basis vector or the length of the DD basis vector is equal to the number of CSI-RS resources or the number of CSI-RS resources within the CSI-RS measurement window configured by the network-side device; determine that the length of the TD basis vector or the length of the DD basis vector is equal to Q₁ times of the number of CSI-RS resources configured by the network-side device; determine that the length of the TD basis vector or the length of the DD basis vector is equal to Q₁ times of the number of CSI-RS resources within the CSI-RS measurement window configured by the network-side device; or determine that the length of the TD basis vector or the length of the DD basis vector is equal to

$$\frac{{N}_{CSI - RS}}{{C}_{u}} {Q}_{1} ,$$

where Q₁ is a positive integer, N_{CSI-RS} represents the number of CSI-RS resources or the number of CSI-RS resources within the CSI-RS measurement window configured by the network-side device, and Cᵤ represents a compression unit in a TD.

In an implementation, the first parameter is a size of a CSI-RS measurement window and an interval between time instances of adjacent CSI measurements. The processing module 702 is specifically configured to determine that the length of the TD basis vector or the length of the DD basis vector is equal to

$$\frac{( {W}_{m e a s} - 1 )}{d} + 1 ,$$

where Wₘₑₐₛ represents the size of the CSI-RS measurement window, and d represents the interval between the time instances of the adjacent CSI measurements, a maximum interval or a minimum interval between adjacent CSI measurements, or an average of intervals of multiple adjacent CSI measurements.

In an implementation, the first parameter is a number of CSI measurements or a number of CSI measurements within a CSI-RS measurement window. The processing module 702 is specifically configured to determine that the length of the TD basis vector or the length of the DD basis vector is equal to the number of CSI-RS measurements or the number of CSI-RS measurements within the CSI-RS measurement window configured by the network-side device; determine that the length of the TD basis vector or the length of the DD basis vector is equal to Q₂ times of the number of CSI measurements configured by the network-side device; determine that the length of the TD basis vector or the length of the DD basis vector is equal to Q₂ times of the number of CSI measurements within the CSI-RS measurement window configured by the network-side device; or determine that the length of the TD basis vector or the length of the DD basis vector is equal to

$$\frac{B}{{C}_{u}} {Q}_{2} ,$$

where Q₂ is a positive integer, B represents the number of CSI measurements or the number of CSI measurements within the CSI-RS measurement window configured by the network-side device, and Cᵤ represents a compression unit in a TD.

In an implementation, the first parameter is a parameter W. The processing module 702 is specifically configured to determine that the length of the TD basis vector or the length of the DD basis vector is equal to

$$\frac{W}{{C}_{u}} ,$$

where W mod Cᵤ=0, and Cᵤ represents a compression unit in a TD; or determine that the length of the TD basis vector or the length of the DD basis vector is equal to

$$⌈ \frac{W}{{C}_{u}} ⌉$$

$$or$$

$$⌊ \frac{W}{{C}_{u}} ⌋ ,$$

where W mod Cᵤ≠0, ┌ ┐ represents ceiling, and └ ┘ represents flooring, in which the parameter W is determined by at least one of following parameters 1) to 4): 1) a time slot corresponding to a CSI reporting time instance; 2) a time slot where a CSI reference resource is located; 3) a time slot corresponding to a left boundary or a right boundary of a CSI-RS measurement window; or 4) a time slot corresponding to a left boundary or a right boundary of a CSI reporting window.

In an implementation, the processing module 702 is further configured to determine the compression unit Cᵤ in the TD.

In an implementation, the compression unit Cᵤ is αT_{c}, where α is an integer less than or equal to 1, and T_{c} represents a channel coherence time; the compression unit Cᵤ is a measurement period of the CSI-RS resource; the compression unit Cᵤ is βd₁, where β is an integer greater than or equal to 1, and d₁ represents the interval between the adjacent CSI measurements; or the compression unit Cᵤ is βd₂, where β is an integer greater than or equal to 1, and d₂ represents the maximum interval or the minimum interval between the adjacent CSI measurement time instances, or the average of the intervals of the multiple adjacent CSI measurements.

In an implementation, the processing module 702 is specifically configured to determine the length of the TD basis vector or the length of the DD basis vector based on Doppler offset information and a Doppler extension reported by the terminal.

In an implementation, the processing module 702 is specifically configured to determine precoding matrixes corresponding to different time instances by employing a codebook structure or a PMI prediction algorithm based on the codebook indication information and a way of determining the length of the TD basis vector or the length of the DD basis vector.

With respect to the apparatus in the above embodiments, the detailed implementation in which each module performs an operation has been described in detail in the method embodiments, which will not be elaborated here.

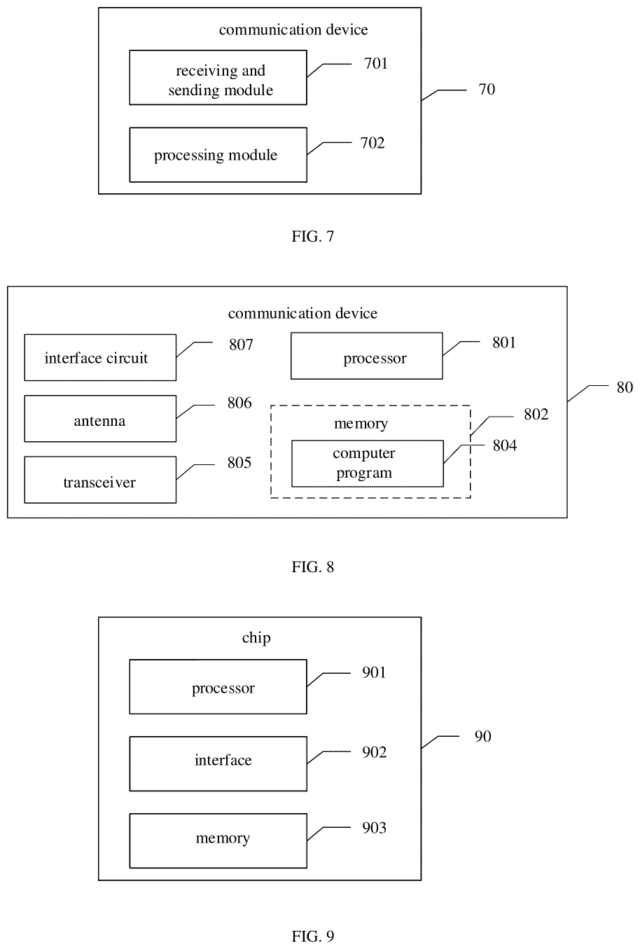

Referring to FIG. 8, FIG. 8 is a block diagram illustrating a communication device according to another embodiment of the disclosure. The communication device 80 may be a network-side device, a terminal, or a chip, a chip system, a processor, etc. that supports the network-side device to implement the above method, or a chip, a chip system, or a processor, etc. that supports the terminal to implement the above method. The device may be used to implement the method in the above method embodiments. For details, please refer to the description in the above method embodiments. The communication device 80 may include one or more processors 801. The processor 801 may be a general-purpose processor or a special-purpose processor, for example, a baseband processor or a central processing unit. The baseband processor may be configured to process communication protocols and communication data, and the central processing unit may be configured to control the communication device (such as a base station, a baseband chip, a terminal, a terminal chip, a DU or CU, etc.), to execute a computer program, and to process computer program data.

Alternatively, the communication device 80 may also include one or more memory 802 for storing a computer program 804. When the computer program 804 is executed by the processor 801, the communication device 80 is caused to perform the method in the above method embodiments. Alternatively, data may also be stored in the memory 802. The communication device 80 and the memory 802 may be separate or integrated together.

Alternatively, the communication device 80 may also include a transceiver 805 and an antenna 806. The transceiver 805 may be called a transceiver unit, a transceiver machine or a transceiver circuit, etc., to implement a receiving and sending function. The transceiver 805 may include a receiver and a sender. The receiver may be called a receiving machine or a receiving circuit, etc. to implement a receiving function; and the sender may be called a sending machine or a sending circuit, etc. to implement a sending function.

Alternatively, the communication device 80 may also include one or more interface circuits 807. The interface circuit 807 is configured to receive code instructions and transmit the code instructions to the processor 801. When the code instructions are run in the processor 801, the communication device 80 is caused to perform the method in the above method embodiments. The communication device 80 is a terminal. The processor 801 is configured to perform actions at block 201 in FIG. 2, and actions at block 301 and block 302 in FIG. 3. The transceiver 805 is configured to perform actions at block 202 in FIG. 2, and actions at block 303 in FIG. 3. The communication device 80 is the network-side device: The transceiver 805 is configured to perform actions at block 401, block 402, and block 405 in FIG. 4; and to perform actions at block step 501, block 502, and block 505 in FIG. 5. The processor 801 is configured to perform actions at block 403 and block 404 in FIG. 4, and to perform actions at block 503 and block 504 in FIG. 5.

In an implementation, the processor 801 may include a transceiver for implementing the receiving and sending function. For example, the transceiver may be a transceiver circuit, an interface, or an interface circuit. The transceiver circuit, interface, or interface circuit for performing the receiving and sending function may be separate or integrated. The transceiver circuit, interface or interface circuit may be configured to read and write code or data, or the transceiver circuit, interface or interface circuit may be configured for the transmission and delivering of signals.

In an implementation, a computer program may be stored in the processor 801. When the computer program is run in the processor 801, the communication device 80 is caused to perform the method in the above method embodiments. The computer program may be solidified in the processor 801. In this case, the processor 801 may be implemented by hardware.

In an implementation, the communication device 80 includes a circuit that may realize the sending or receiving or communicating function in the above method embodiments. The processor and transceiver in the disclosure may be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device in the above embodiments may be the network-side device or the terminal, but the scope of the communication device in the disclosure is not limited to this, and the structure of the communication device may not be limited by FIG. 8. The communication device may be an independent device or part of a larger device. For example, the communication device may be:
(1) an independent IC, or a chip, or a chip system or a subsystem;
(2) a collection including one or more IC, alternatively, the IC collection also including storage components for storing data and computer programs;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network-side device, a cloud device, an artificial intelligence device, etc.;
(6) others.

For the case where the communication device may be the chip or the chip system, please refer to the block diagram of a chip in FIG. 9. The chip illustrated in FIG. 9 includes a processor 901 and an interface 903. There may be one or more processors 901, and there may be one or more interfaces 902.

For the case where the chip is configured to realize the function of the terminal in the embodiments of the disclosure:
the processor 901 is configured to determine codebook indication information corresponding to a data transmission layer based on a length of a TD basis vector or a length of a DD basis vector, and a codebook parameter configured by a network-side device; the interface 902 is configured to send CSI including the codebook indication information to the network-side device, in which the codebook indication information indicates the network-side device to determine precoding matrixes corresponding to different time instances.

In an implementation, the processor 901 is specifically configured to determine the length of the TD basis vector or the length of the DD basis vector; and determine the codebook indication information corresponding to the data transmission layer based on the length and the codebook parameter configured by the network-side device.

In an implementation, the processor 901 is specifically configured to determine the length of the TD basis vector or the length of the DD basis vector based on a first parameter configured by the network-side device.

In an implementation, the first parameter is a number of CSI-RS resources or a number of CSI-RS resources within a CSI-RS measurement window. The processer 901 is specifically configured to determine that the length of the TD basis vector or the length of the DD basis vector is equal to the number of CSI-RS resources or the number of CSI-RS resources within the CSI-RS measurement window configured by the network-side device; determine that the length of the TD basis vector or the length of the DD basis vector is equal to Q₁ times of the number of CSI-RS resources configured by the network-side device; determine that the length of the TD basis vector or the length of the DD basis vector is equal to Q₁ times of the number of CSI-RS resources within the CSI-RS measurement window configured by the network-side device; or determine that the length of the TD basis vector or the length of the DD basis vector is equal to

$$\frac{{N}_{CSI - RS}}{{C}_{u}} {Q}_{1} ,$$

where Q₁ is a positive integer, N_{CSI-RS} resents the number of CSI-RS resources or the number of CSI-RS resources within CSI-RS measurement window configured by the network-side device, and Cᵤ represents a compression unit in a TD.

In an implementation, the first parameter is a size of a CSI-RS measurement window and an interval between time instances of adjacent CSI measurements. The processer 901 is specifically configured to determine that the length of the TD basis vector or the length of the DD basis vector is equal to

$$\frac{( {W}_{m e a s} - 1 )}{d} + 1 ,$$

where Wₘₑₐₛ represents the size of the CSI-RS measurement window, and d represents the interval between the time instances of the adjacent CSI measurements, d represents a maximum interval or a minimum interval between adjacent CSI measurements, or d represents an average of intervals of multiple adjacent CSI measurements.

In an implementation, the first parameter is a number of CSI measurements or a number of CSI measurements within a CSI-RS measurement window. The processer 901 is specifically configured to determine that the length of the TD basis vector or the length of the DD basis vector is equal to the number of CSI measurements or the number of CSI measurements within the CSI-RS measurement window configured by the network-side device; determine that the length of the TD basis vector or the length of the DD basis vector is equal to Q₂ times of the number of CSI measurements configured by the network-side device; determine that the length of the TD basis vector or the length of the DD basis vector is equal to Q₂ times of the number of CSI measurements within the CSI-RS measurement window configured by the network-side device; or determine that the length of the TD basis vector or the length of the DD basis vector is equal to

$$\frac{B}{{C}_{u}} {Q}_{2} ,$$

where Q₂ is a positive integer, B Cᵤ represents the number of CSI measurements or the number of CSI measurements within the CSI-RS measurement window configured by the network-side device, and Cᵤ represents a compression unit in a TD.

In an implementation, the first parameter is a parameter W. The processer 901 is specifically configured to determine that the length of the TD basis vector or the length of the DD basis vector is equal to

$$\frac{W}{{C}_{u}} ,$$

where W mod Cᵤ=0, Cᵤ represents a compression unit in a TD; or determine that the length of the TD basis vector or the length of the DD basis vector is equal to

$$⌈ \frac{W}{{C}_{u}} ⌉$$

$$or$$

$$⌊ \frac{W}{{C}_{u}} ⌋ ,$$

where W mod Cᵤ≠0, ┌ ┐ represents ceiling, and └ ┘ represents flooring, in which the parameter W is determined by at least one of following parameters 1) to 4): 1) a time slot corresponding to a CSI reporting time instance; 2) a time slot where a CSI reference resource is located; 3) a time slot corresponding to a left boundary or a right boundary of a CSI-RS measurement window; or 4) a time slot corresponding to a left boundary or a right boundary of a CSI reporting window.

In an implementation, the processer 901 is further configured to determine the compression unit Cᵤ in the TD.

In an implementation, the compression unit Cᵤ is αT_{c}, where α is an integer less than or equal to 1, and T_{c} represents a channel coherence time; the compression unit Cᵤ is a measurement period of the CSI-RS resource; the compression unit Cᵤ is βd₁, where β is an integer greater than or equal to 1, and d₁ represents the interval between the time instances of the adjacent CSI measurements; or the compression unit Cᵤ is βd₂, where β is an integer greater than or equal to 1, and d₂ represents the maximum interval or the minimum interval between the adjacent CSI measurements, or d₂ may also represents the average of the intervals of the multiple adjacent CSI measurements.

In an implementation, the processer 901 is specifically configured to determine the length of the TD basis vector or the length of the DD basis vector based on Doppler offset information and a Doppler extension estimated by the terminal employing a CSI-RS.

In an implementation, the interface 902 is further configured to receive the length of the TD basis vector or the length of the DD basis vector configured by the network-side device.

In an implementation, the codebook indication information at least includes one or more combinations of: a matrix combined by at least one SD basis vector, a combination coefficient matrix, a matrix combined by at least one FD basis vector, or a matrix combined by at least one TD basis vector or at least one DD basis vector.

For the case where the chip is configured to realize the function of the network-side device in the embodiments of the disclosure:

The processor 901 is configured to determine a length of a TD basis vector or a length of a DD basis vector; the processor 901 further configures a codebook parameter for a terminal; the interface 902 is configured to send the length of the TD basis vector or the length of the DD basis vector and the codebook parameter to the terminal; the interface 902 is further configured to receive codebook indication information corresponding to a data transmission layer determined by the terminal based on the length and the codebook parameter; and the processor 901 is further configured to determine precoding matrixes corresponding to different time instances based on the codebook indication information.

In an implementation, the processor 901 is configured to determine the length of the TD basis vector or the length of the DD basis vector based on a first parameter configured by the network-side device.

In an implementation, the first parameter is a number of CSI-RS resources or a number of CSI-RS resources within a CSI-RS measurement window. The processer 901 is specifically configured to determine that the length of the TD basis vector or the length of the DD basis vector is equal to the number of CSI-RS resources or the number of CSI-RS resources within the CSI-RS measurement window configured by the network-side device; determine that the length of the TD basis vector or the length of the DD basis vector is equal to Q₁ times of the number of CSI-RS resources configured by the network-side device; determine that the length of the TD basis vector or the length of the DD basis vector is equal to Q₁ times of the number of CSI-RS resources within the CSI-RS measurement window configured by the network-side device; or determine that the length of the TD basis vector or the length of the DD basis vector is equal to

$$\frac{{N}_{CSI - RS}}{{C}_{u}} {Q}_{1} ,$$

where Q₁ is a positive integer, N_{CSI-RS} represents the number of CSI-RS resources or the number of CSI-RS resources within the CSI-RS measurement window configured by the network-side device, and Cᵤ represents a compression unit in a TD.

In an implementation, the first parameter is a size of a CSI-RS measurement window and an interval between time instances of adjacent CSI measurements. The processer 901 is specifically configured to determine that the length of the TD basis vector or the length of the DD basis vector is equal to

$$\frac{( {W}_{m e a s} - 1 )}{d} + 1 ,$$

where Wₘₑₐₛ represents the size of the CSI-RS measurement window, and d represents the interval between the time instances of the adjacent CSI measurements, d represents a maximum interval or a minimum interval between adjacent CSI measurements, or d represents an average of intervals of multiple adjacent CSI measurements.

In an implementation, the first parameter is a number of CSI measurements or a number of CSI measurements within a CSI-RS measurement window. The processer 901 is specifically configured to determine that the length of the TD basis vector or the length of the DD basis vector is equal to the number of CSI-RS measurements or the number of CSI-RS measurements within the CSI-RS measurement window configured by the network-side device; determine that the length of the TD basis vector or the length of the DD basis vector is equal to Q₂ times of the number of CSI measurements configured by the network-side device; determine that the length of the TD basis vector or the length of the DD basis vector is equal to Q₂ times of the number of CSI measurements within the CSI-RS measurement window configured by the network-side device; or determine that the length of the TD basis vector or the length of the DD basis vector is equal to

$$\frac{B}{{C}_{u}} {Q}_{2} ,$$

where Q₂ is a positive integer, B represents the number of CSI measurements or the number of CSI measurements within the CSI-RS measurement window configured by the network-side device, and Cᵤ represents a compression unit in a TD.

In an implementation, the first parameter is a parameter W. The processer 901 is specifically configured to determine that the length of the TD basis vector or the length of the DD basis vector is equal to

$$\frac{W}{{C}_{u}} ,$$

where W mod Cᵤ=0, and Cᵤ represents a compression unit in a TD; or determine that the length of the TD basis vector or the length of the DD basis vector is equal to

$$⌈ \frac{W}{{C}_{u}} ⌉$$

$$or$$

$$⌊ \frac{W}{{C}_{u}} ⌋ ,$$

where W mod Cᵤ≠0, ┌ ┐ represents ceiling, and └ ┘ represents flooring, in which the parameter W is determined by at least one of following parameters 1) to 4): 1) a time slot corresponding to a CSI reporting time instance; 2) a time slot where a CSI reference resource is located; 3) a time slot corresponding to a left boundary or a right boundary of a CSI-RS measurement window; or 4) a time slot corresponding to a left boundary or a right boundary of a CSI reporting window.

In an implementation, the processer 901 is further configured to determine the compression unit Cᵤ in the TD.

In an implementation, the compression unit Cᵤ is αT_{c}, where α is an integer less than or equal to 1, and T_{c} represents a channel coherence time; the compression unit Cᵤ is a measurement period of the CSI-RS resource; the compression unit Cᵤ is βd₁, where β is an integer greater than or equal to 1, and d₁ represents the interval between the time instances of the adjacent CSI measurements; or the compression unit Cᵤ is βd₂, where β is an integer greater than or equal to 1, and d₂ represents the maximum interval or the minimum interval between the adjacent CSI measurements, or d₂ may also represents the average of the intervals of the multiple adjacent CSI measurements.

In an implementation, the processer 901 is specifically configured to determine the length of the TD basis vector or the length of the DD basis vector based on Doppler offset information and a Doppler extension reported by the terminal.

In an implementation, the processer 901 is specifically configured to determine precoding matrixes corresponding to different time instances by employing a codebook structure or a PMI prediction algorithm based on the codebook indication information and a way of determining the length of the TD basis vector or the length of the DD basis vector.

Alternatively, the chip also includes a memory 903 for storing necessary computer programs and data.

Those skilled in the art may also understand that the various illustrative logical blocks and steps listed in embodiments of the disclosure may be realized by electronic hardware, computer software, or their combination. Whether such a function is realized in hardware or software depends on specific applications and design requirements of the overall system. Those skilled in the art may, for each specific application, use a variety of methods to achieve the above function, but such implementation shall not be regarded as going beyond the scope of the protection of the embodiments of the disclosure.

The embodiments of the disclosure also provide a communication system. The communication system includes a communication device as the terminal and a communication device as the network-side device in the embodiments illustrated in FIG. 7, or, the system includes a communication device as the terminal and a communication device as the network-side device in the embodiments illustrated in FIG. 8.

The disclosure also provides a readable storage medium for storing instructions. When instructions are executed by a computer, a function of any one of the above method embodiments is realized.

The disclosure also provides a computer program product. When the computer program product is performed by a computer, a function of any one of the above method embodiments is realized.

In the above embodiments, the functions may be wholly or partially realized by software, hardware, firmware, or any combination of them. When realized by software, the functions may be realized in whole or in part in the form of a computer program product. The computer program product includes one or more computer programs. Procedures or functions according to embodiments of the disclosure are wholly or partially generated when the computer program is loaded and performed in a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center in a wire way (such as a coaxial cable, a fiber optic, a digital subscriber line (DSL)) or in a wireless way (such as infrared, wireless, microwave). The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that numerical numbers like first and second in the disclosure are only for the convenience of description, and do not limit the scope of the embodiments of the disclosure, and also indicate the sequential order.

The term “at least one” in the disclosure may also be described as one or more, and the more may be two, three, four, or more, which is not limited in the disclosure. In the embodiment of the disclosure, for a type of technical features, technical features in the type of technical features are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Corresponding relationships indicated by tables in the disclosure may be configured or predefined. Values of information in the tables are only examples, and may be configured as other values, which are not limited in the disclosure. When the corresponding relationship between information and parameters is configured, there no need to configure all corresponding relationships indicated in tables. For example, in the tables of the disclosure, corresponding relationships indicated by some rows may not be configured. For another example, appropriate transformations and adjustments, such as splitting and merging, may be made based on the above tables. Names of parameters illustrated in headers of the tables may be other names understandable by the communication apparatus, and values or representations of the parameters may be other values or representations understandable by the communication apparatus. When the above tables are implemented, other data structures may be employed, for example, arrays, queues, containers, stacks, linear lists, pointers, linked lists, trees, graphs, structures, classes, heaps or hash tables may be employed.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the disclosure, may be implemented by an electronic hardware or a combination of an electronic hardware and a computer software. Whether the functions are performed by the hardware or the software depends on a specific application and a design constraint of the technical solutions. Those skilled in the art may adopt different ways for each specific application to realize the described functions, but such realization should not be considered as going beyond the scope of the disclosure.

Those skilled in the art may clearly understand that, for convenience and conciseness of description, a detailed working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be contained within the protection scope of the disclosure. Therefore, the protection scope of the disclosure shall be subject to the protection scope of claims.

1. A method for feeding back channel state information (CSI), performed by a terminal, comprising:
determining codebook indication information corresponding to a data transmission layer based on a length of a time domain (TD) basis vector or a length of a Doppler domain (DD) basis vector, and a codebook parameter configured by a network-side device; and
sending CSI comprising the codebook indication information to the network-side device, wherein the codebook indication information indicates the network-side device to determine precoding matrixes corresponding to different time instances.

2. The method of claim 1, wherein determining the codebook indication information corresponding to the data transmission layer based on the length of the TD basis vector or the length of the DD basis vector, and the codebook parameter configured by the network-side device, comprises:
determining the length of the TD basis vector or the length of the DD basis vector; and
determining the codebook indication information corresponding to the data transmission layer based on the length and the codebook parameter configured by the network-side device.

3. The method of claim 2, wherein determining the length of the TD basis vector or the length of the DD basis vector comprises:
determining the length of the TD basis vector or the length of the DD basis vector based on a first parameter configured by the network-side device.

4. The method of claim 3, wherein the first parameter is a number of channel state information reference signal (CSI-RS) resources or a number of CSI-RS resources within a CSI-RS measurement window, and determining the length of the TD basis vector or the length of the DD basis vector based on the first parameter configured by the network-side device comprises one of:
determining that the length of the TD basis vector or the length of the DD basis vector is equal to the number of CSI-RS resources or the number of CSI-RS resources within the CSI-RS measurement window configured by the network-side device;
determining that the length of the TD basis vector or the length of the DD basis vector is equal to Q₁ times of the number of CSI-RS resources configured by the network-side device;
determining that the length of the TD basis vector or the length of the DD basis vector is equal to Q₁ times of the number of CSI-RS resources within the CSI-RS measurement window configured by the network-side device; or
determining that the length of the TD basis vector or the length of the DD basis vector is equal to
$$\frac{{N}_{CSI - RS}}{{C}_{u}} {Q}_{1} ,$$
where Q₁ is a positive integer, N_{CSI-RS} represents the number of CSI-RS resources or the number of CSI-RS resources within the CSI-RS measurement window configured by the network-side device, and Cᵤ represents a compression unit in a TD.

5. The method of claim 3, wherein the first parameter is a size of a channel state information reference signal (CSI-RS) measurement window and an interval between time instances of adjacent CSI measurements, and determining the length of the TD basis vector or the length of the DD basis vector based on the first parameter configured by the network-side device comprises:
determining that the length of the TD basis vector or the length of the DD basis vector is equal to
$$\frac{( {W}_{m e a s} - 1 )}{d} + 1 ,$$
where Wₘₑₐₛ represents the size of the CSI-RS measurement window, and d represents the interval between the time instances of the adjacent CSI measurements, a maximum interval or a minimum interval in intervals between time instances of a plurality of adjacent CSI measurements, or an average of intervals between time instances of a plurality of adjacent CSI measurements.

6. The method of claim 3, wherein the first parameter is a number of CSI measurements or a number of CSI measurements within a channel state information reference signal (CSI-RS) measurement window, and determining the length of the TD basis vector or the length of the DD basis vector based on the first parameter configured by the network-side device comprises one of:
determining that the length of the TD basis vector or the length of the DD basis vector is equal to the number of CSI measurements or the number of CSI measurements within the CSI-RS measurement window configured by the network-side device;
determining that the length of the TD basis vector or the length of the DD basis vector is equal to Q₂ times of the number of CSI measurements configured by the network-side device;
determining that the length of the TD basis vector or the length of the DD basis vector is equal to Q₂ times of the number of CSI measurements within the CSI-RS measurement window configured by the network-side device; or
determining that the length of the TD basis vector or the length of the DD basis vector is equal to
$$\frac{B}{{C}_{u}} {Q}_{2} ,$$
where Q₂ is a positive integer, B represents the number of CSI measurements or the number of CSI measurements within the CSI-RS measurement window configured by the network-side device, and Cᵤ represents a compression unit in a TD.

7. The method of claim 3, wherein the first parameter is a parameter W, and determining the length of the TD basis vector or the length of the DD basis vector based on the first parameter configured by the network-side device comprises one of:
determining that the length of the TD basis vector or the length of the DD basis vector is equal to
$$\frac{W}{{C}_{u}} ,$$
where W mod Cᵤ=0, and Cᵤ represents a compression unit in a TD; or
determining that the length of the TD basis vector or the length of the DD basis vector is equal to
$$⌈ \frac{W}{{C}_{u}} ⌉ or ⌊ \frac{W}{{C}_{u}} ⌋ ,$$
where W mod Cᵤ≠0, ┌ ┐ represents ceiling, and └ ┘ represents flooring,
wherein the parameter W is determined by at least one of:
a time slot corresponding to a CSI reporting time instance;
a time slot where a CSI reference resource is located;
a time slot corresponding to a left boundary or a right boundary of a channel state information reference signal (CSI-RS) measurement window; or
a time slot corresponding to a left boundary or a right boundary of a CSI reporting window.

8. The method of claim 4, further comprising:
determining the compression unit Cᵤ in the TD,
wherein the compression unit Cᵤ is one of:
αT_{c}, where α is an integer less than or equal to 1, and T_{c} represents a channel coherence time;
a measurement period of the CSI-RS resource;
βd₁, where β is an integer greater than or equal to 1, and d₁ represents the interval between the time instances of the adjacent CSI measurements; or
βd₂, where β is an integer greater than or equal to 1, and d₂ represents the maximum interval or the minimum interval in the intervals between the time instances of the plurality of adjacent CSI measurements, or the average of the intervals between the time instances of the plurality of adjacent CSI measurements.

9. (canceled)

10. The method of claim 2, wherein determining the length of the TD basis vector or the length of the DD basis vector comprises one of:
determining the length of the TD basis vector or the length of the DD basis vector based on Doppler offset information and a Doppler extension estimated by the terminal based on a channel state information reference signal (CSI-RS); or
receiving the length of the TD basis vector or the length of the DD basis vector configured by the network-side device.

11. (canceled)

12. The method of claim 1, wherein the codebook indication information at least comprises one or more combinations of: a matrix combined by at least one spatial domain (SD) basis vector, a combination coefficient matrix, a matrix combined by at least one frequency domain (FD) basis vector, or a matrix combined by at least one time domain (TD) basis vector or at least one Doppler domain (DD) basis vector.

13. A method for feeding back channel state information (CSI), performed by a network-side device, comprising:
determining a length of a time domain (TD) basis vector or a length of a Doppler domain (DD) basis vector;
configuring a codebook parameter for a terminal;
sending the length of the TD basis vector or the length of the DD basis vector and the codebook parameter to the terminal;
receiving codebook indication information corresponding to a data transmission layer determined by the length and the codebook parameter of the terminal; and
determining precoding matrixes corresponding to different time instances based on the codebook indication information.

14. The method of claim 13, wherein determining the length of the TD basis vector or the length of the DD basis vector comprises:
determining the length of the TD basis vector or the length of the DD basis vector based on a first parameter configured by the network-side device.

15. The method of claim 14, wherein the first parameter is a number of channel state information reference signal (CSI-RS) resources or a number of CSI-RS resources within a CSI-RS measurement window, and determining the length of the TD basis vector or the length of the DD basis vector based on the first parameter configured by the network-side device comprises one of:
determining that the length of the TD basis vector or the length of the DD basis vector is equal to the number of CSI-RS resources or the number of CSI-RS resources within the CSI-RS measurement window configured by the network-side device;
determining that the length of the TD basis vector or the length of the DD basis vector is equal to Q₁ times of the number of CSI-RS resources configured by the network-side device;
determining that the length of the TD basis vector or the length of the DD basis vector is equal to Q₁ times of the number of CSI-RS resources within the CSI-RS measurement window configured by the network-side device; or
determining that the length of the TD basis vector or the length of the DD basis vector is equal to
$$\frac{{N}_{CSI - RS}}{{C}_{u}} {Q}_{1} ,$$
where Q₁ is a positive integer, N_{CSI-RS} represents the number of CSI-RS resources or the number of CSI-RS resources within the CSI-RS measurement window configured by the network-side device, and Cᵤ represents a compression unit in a TD.

16. The method of claim 14, wherein the first parameter is a size of a channel state information reference signal (CSI-RS) measurement window and an interval between time instances of adjacent CSI measurements, and determining the length of the TD basis vector or the length of the DD basis vector based on the first parameter configured by the network-side device comprises:
determining that the length of the TD basis vector or the length of the DD basis vector is equal to
$$\frac{( {W}_{m e a s} - 1 )}{d} + 1 ,$$
where Wₘₑₐₛ represents the size of the CSI-RS measurement window, and d represents the interval between the time instances of the adjacent CSI measurements, a maximum interval or a minimum interval in intervals between time instances of a plurality of adjacent CSI measurements, or an average of intervals between time instances of a plurality of adjacent CSI measurements.

17. The method of claim 14, wherein the first parameter is a number of CSI measurements or a number of CSI measurements within a channel state information reference signal (CSI-RS) measurement window, and determining the length of the TD basis vector or the length of the DD basis vector based on the first parameter configured by the network-side device comprises one of:
determining that the length of the TD basis vector or the length of the DD basis vector is equal to the number of CSI measurements or the number of CSI measurements within the CSI-RS measurement window configured by the network-side device;
determining that the length of the TD basis vector or the length of the DD basis vector is equal to Q₂ times of the number of CSI measurements configured by the network-side device;
determining that the length of the TD basis vector or the length of the DD basis vector is equal to Q₂ times of the number of CSI measurements within the CSI-RS measurement window configured by the network-side device; or
determining that the length of the TD basis vector or the length of the DD basis vector is equal to
$$\frac{B}{{C}_{u}} {Q}_{2} ,$$
where Q₂ is a positive integer, B represents the number of CSI measurements or the number of CSI measurements within the CSI-RS measurement window configured by the network-side device, and Cᵤ represents a compression unit in a TD.

18. The method of claim 14, wherein the first parameter is a parameter W, and determining the length of the TD basis vector or the length of the DD basis vector based on the first parameter configured by the network-side device comprises one of:
determining that the length of the TD basis vector or the length of the DD basis vector is equal to
$$\frac{W}{{C}_{u}} ,$$
where W mod Cᵤ=0, and Cᵤ represents a compression unit in a TD; or
determining that the length of the TD basis vector or the length of the DD basis vector is equal to
$$⌈ \frac{W}{{C}_{u}} ⌉ or ⌊ \frac{W}{{C}_{u}} ⌋ ,$$
where W mod Cᵤ≠0, ┌ ┐ represents ceiling, and └ ┘ represents flooring,
wherein the parameter W is determined by at least one of:
a time slot corresponding to a CSI reporting time instance;
a time slot where a CSI reference resource is located;
a time slot corresponding to a left boundary or a right boundary of a channel state information reference signal (CSI-RS) measurement window; or
a time slot corresponding to a left boundary or a right boundary of a CSI reporting window.

19. The method of claim 15, further comprising:
determining the compression unit Cᵤ in the TD,
wherein the compression unit Cᵤ is one of:
αT_{c}, where α is an integer less than or equal to 1, and T_{c} represents a channel coherence time;
a measurement period of the CSI-RS resource;
βd₁, where β is an integer greater than or equal to 1, and d₁ represents the interval between the time instances of the adjacent CSI measurements; or
βd₂, where β is an integer greater than or equal to 1, and d₂ represents the maximum interval or the minimum interval in the intervals between the plurality of time instances of the adjacent CSI measurements, or the average of the intervals between the plurality of time instances of the plurality of adjacent CSI measurements.

20. (canceled)

21. The method of claim 13, wherein determining the length of the TD basis vector or the length of the DD basis vector comprises:
determining the length of the TD basis vector or the length of the DD basis vector based on Doppler offset information and a Doppler extension reported by the terminal,
wherein determining precoding matrixes corresponding to different time instances based on the codebook indication information comprises:
determining precoding matrixes corresponding to different time instances by employing a codebook structure or a precoding matrix indicator (PMI) prediction algorithm based on the codebook indication information and a way of determining the length of the TD basis vector or the length of the DD basis vector.

22.-44. (canceled)

45. A terminal, comprising:
a processor; and
a memory for storing a computer program executable by the processor,
wherein the processor is configured to:
determine codebook indication information corresponding to a data transmission layer based on a length of a time domain (TD) basis vector or a length of a Doppler domain (DD) basis vector, and a codebook parameter configured by a network-side device; and
send channel state information (CSJ) comprising the codebook indication information to the network-side device, wherein the codebook indication information indicates the network-side device to determine precoding matrixes corresponding to different time instances.

46. A network-side device, comprising:
a processor; and
a memory for storing a computer program executable by the processor,
wherein the processor is configured to perform the method of claim 13.

47. (canceled)

48. (canceled)
